(19) United States
(12) Patent Application Publication
(10) Pub. No.: US 2023/0351024 A1
(43) Pub. Date: Nov. 2, 2023

(54) SYSTEM AND METHOD FOR SECURITY SCANNING AND PATCHING SDDCS IN A MULTI-CLOUD ENVIRONMENT

(71) Applicant: VMWARE, INV., Palo Alto, CA (US)

(72) Inventors: JON COOK, San Jose, CA (US); Shubham Shashikant Patil, Bangalore (IN); Thomas Ralph, Monument, CO (US)

(21) Appl. No.: 17/839,512

(22) Filed: Jun. 14, 2022

(30) Foreign Application Priority Data
Apr. 30, 2022 (IN) 202241025404

(51) Int. Cl. G06F 9/50; G06F 21/57

(52) U.S. Cl. CPC G06F 21/577; G06F 9/505; G06F 9/5072

(57) ABSTRACT

System and computer-implemented method for scanning software-defined data centers (SDDCs) for vulnerabilities uses at least one vulnerability detector listed on vulnerability scan definitions for the vulnerabilities to scan at least one component in each of target SDDCs. Each of the vulnerability scan definitions specifies at least one triggering condition for determining a specific vulnerability using the at least one vulnerability detector. An alert is then generated for each vulnerability found in the target SDDCs so that a remediation is performed to resolve that vulnerability.

### RELATED APPLICATIONS

Benefit is claimed under 35 U.S.C. 119(a)-(d) to Foreign Application Serial No. 202241025404 filed in India entitled “SYSTEM AND METHOD FOR SECURITY SCANNING AND PATCHING SDDCS IN A MULTI-CLOUD ENVIRONMENT”, on Apr. 30, 2022, by VMware, Inc., which is herein incorporated in its entirety by reference for all purposes.

### BACKGROUND

Current hybrid cloud technologies allow software-defined data centers (SDDCs) to be deployed in a public cloud. These hybrid cloud technologies allow entities, such as enterprises, to modernize, protect and scale their applications leveraging the public cloud without having to manage the infrastructure. However, some entities do not want to move some of their SDDCs to the public cloud, either because the data cannot leave their premises, or the compute power needs to be close to the applications at their edge locations.

As a result, managed and unmanaged on-prem solutions have been developed so that SDDCs of entities may reside on-premises, as well as the public cloud. However, due to the various SDDC offerings, executing troubleshooting and patching operations on these various SDDCs can present challenges.

### SUMMARY

System and computer-implemented method for scanning software-defined data centers (SDDCs) for vulnerabilities uses at least one vulnerability detector listed in vulnerability scan definitions for the vulnerabilities to scan at least one component in each of target SDDCs. Each of the vulnerability scan definitions specifies at least one triggering condition for determining a specific vulnerability using the at least one vulnerability detector. An alert is then generated for each vulnerability found in the target SDDCs so that a remediation is performed to resolve that vulnerability.

A computer-implemented method for scanning software-defined data centers (SDDCs) for vulnerabilities comprises determining target SDDCs to be scanned among a plurality of SDDCs running on distributed computing environments, scanning at least one component in each of the target SDDCs using at least one vulnerability detector listed on vulnerability scan definitions for the vulnerabilities, wherein each of the vulnerability scan definitions specifies at least one triggering condition for determining a specific vulnerability using the at least one vulnerability detector, and generating an alert for each vulnerability found in the target SDDCs so that a remediation is performed to resolve that vulnerability. In some embodiments, the steps of this method are performed when program instructions contained in a computer-readable storage medium are executed by one or more processors.

A system in accordance with an embodiment of the invention comprises memory and at least one processor configured to determine target SDDCs to be scanned among a plurality of SDDCs running on distributed computing environments, scan at least one component in each of the target SDDCs using at least one vulnerability detector listed on vulnerability scan definitions for the vulnerabilities, wherein each of the vulnerability scan definitions specifies at least one triggering condition for determining a specific vulnerability using the at least one vulnerability detector, and generate an alert for each vulnerability found in the target SDDCs so that a remediation is performed to resolve that vulnerability.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a computing system with a remediating and troubleshooting service (RTS) in accordance with an embodiment of the invention.

FIG. 2 is a diagram of a representative software-defined data center (SDDC) that may be implemented in the computing system shown in FIG. 1 in accordance with an embodiment of the invention.

FIG. 3A shows a sample vulnerability scan definition using Hypertext Transfer Protocol (HTTP) GET that may be used in the computing system shown in FIG. 1 in accordance with an embodiment of the invention.

FIG. 3B shows a sample vulnerability scan definition using HTTP POST that may be used in the computing system shown in FIG. 1 in accordance with an embodiment of the invention.

FIG. 4 shows a sample patch definition that may be used in the computing system shown in FIG. 1 in accordance with an embodiment of the invention.

FIG. 5 is a diagram of components of the RTS and a cloud service in the computing system shown in FIG. 1 in accordance with an embodiment of the invention.

FIG. 6 is a flow diagram of a process of scanning SDDCs in the computing system shown in FIG. 1 for vulnerabilities in accordance with an embodiment of the invention.

FIG. 7 is a flow diagram of a process of patching an SDDC in the computing system shown in FIG. 1 in accordance with an embodiment of the invention.

FIG. 8 shows components used by the RTS to alert an incident management system in accordance with an embodiment of the invention.

FIG. 9 is a process flow diagram of a computer-implemented method for scanning software-defined data centers (SDDCs) for vulnerabilities in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

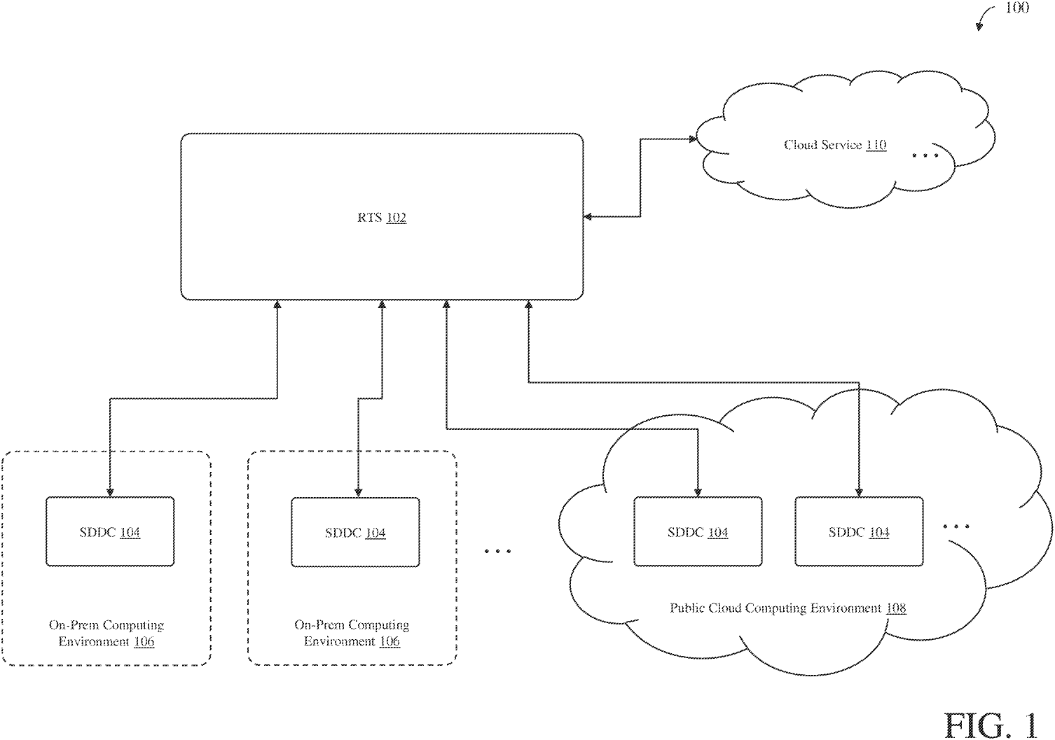

FIG. 1 shows a computing system 100 with a remediating and troubleshooting service (RTS) 102 in accordance with an embodiment of the invention. The RTS 102 provides vulnerability scanning and patching services for software-defined data centers (SDDCs) 104, which may be located in one or more on-premises computing environments 106 or one or more public cloud computing environments 108, such as AWS or Google clouds. As explained below, the RTS 102 uses vulnerability scan definitions as vulnerability signatures and patch definitions as patch metadata to efficiently execute vulnerability scans and patching operations throughout a fleet of SDDCs for entities, which may be business entities, such as business enterprises.

As shown in FIG. 1, the computing system 100 further includes a cloud service 110, which manages the SDDCs 104 in the public cloud computing environments 108 and at least some of the SDDCs 104 in the on-premises computing environments 106. The cloud service 110 can reside in any computing environment, such as one of the on-premises computing environments 106 or one of the public cloud computing environments 108. The cloud service 110 may also provide support for the RTS 102 to execute vulnerability scans and patching operations on select SDDCs 104. As explained below, the RTS 102 also closely operates with the cloud service or the on-premises operational environment of an entity, which may provide at least some of the computing environments of the computing system, to perform its operations.

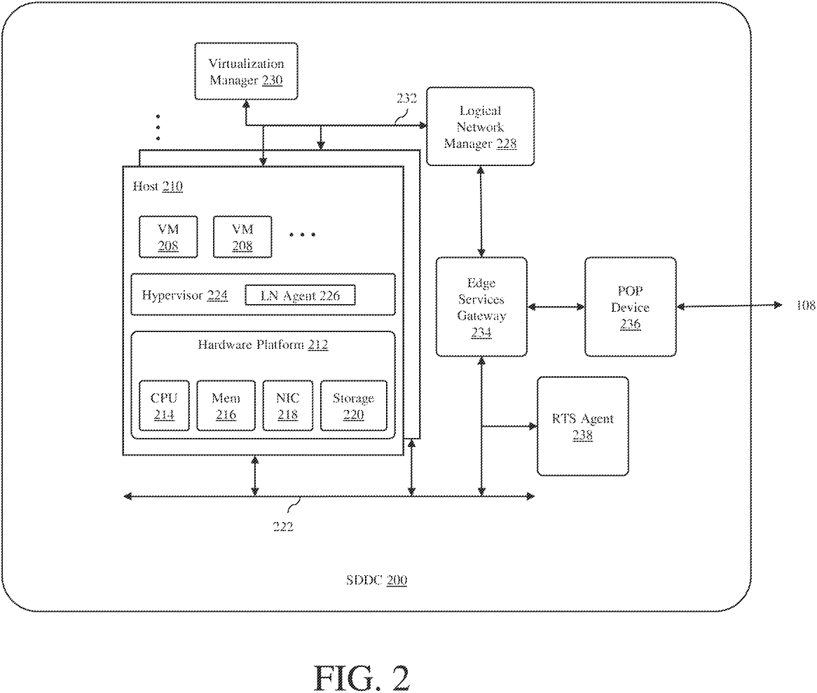

Turning now to FIG. 2, a representative SDDC 200 that may be implemented in the computing system 100 in accordance with an embodiment of the invention is illustrated. Thus, the SDDC 200 is an example of the SDDCs 104 shown in FIG. 1. The SDDC 200 may be deployed in a public cloud computing environment or in an on-premises computing environment. If in an on-premises computing environment, the SDDC 200 may be either a managed SDDC (i.e., an SDDC that is managed by a service provider) or an unmanaged SDDC (i.e., an SDDC that is managed by the SDDC owner, not by a service provider).

As shown in FIG. 2, the SDDC 200 includes one or more host computer systems (“hosts”) 210. The hosts may be constructed on a server grade hardware platform 212, such as an x86 architecture platform. As shown, the hardware platform of each host may include conventional components of a computing device, such as one or more processors (e.g., CPUs) 214, system memory 216, a network interface 218, and storage 220. The processor 214 can be any type of a processor commonly used in servers. The memory 216 is volatile memory used for retrieving programs and processing data. The memory 216 may include, for example, one or more random access memory (RAM) modules. The network interface 218 enables the host 210 to communicate with other devices that are inside or outside of the SDDC 200 via a communication medium, such as a network 222. The network interface 218 may be one or more network adapters, also referred to as network interface cards (NICs). The storage 220 represents one or more local storage devices (e.g., one or more hard disks, flash memory modules, solid state disks and/or optical disks), which may be used to form a virtual storage area network (SAN).

Each host 210 may be configured to provide a virtualization layer that abstracts processor, memory, storage and networking resources of the hardware platform 212 into virtual computing instances, e.g., virtual machines 208, that run concurrently on the same host. The virtual machines run on top of a software interface layer, which is referred to herein as a hypervisor 224, that enables sharing of the hardware resources of the host by the virtual machines. One example of the hypervisor 224 that may be used in an embodiment described herein is a VMware ESXi™ hypervisor provided as part of the VMware vSphere® solution made commercially available from VMware, Inc. The hypervisor 224 may run on top of the operating system of the host or directly on hardware components of the host. For other types of virtual computing instances, the host may include other virtualization software platforms to support those virtual computing instances, such as Docker virtualization platform to support “containers.”

In the illustrated embodiment, the hypervisor 224 includes a logical network (LN) agent 226, which operates to provide logical networking capabilities, also referred to as “software-defined networking” (SDN). Each logical network may include software managed and implemented network services, such as bridging, L3 routing, L2 switching, network address translation (NAT), and firewall capabilities, to support one or more logical overlay networks in the SDDC 200. The logical network agent 226 receives configuration information from a logical network manager 228 (which may include a control plane cluster) and, based on this information, populates forwarding, firewall and/or other action tables for dropping or directing packets between the virtual machines 208 in the host 210, other virtual machines on other hosts, and/or other devices outside of the SDDC 200. Collectively, the logical network agent 226, together with other logical network agents on other hosts, according to their forwarding/routing tables, implement isolated overlay networks that can connect arbitrarily selected virtual machines with each other. Each virtual machine may be arbitrarily assigned a particular logical network in a manner that decouples the overlay network topology from the underlying physical network. Generally, this is achieved by encapsulating packets at a source host and decapsulating packets at a destination host so that virtual machines on the source and destination can communicate without regard to underlying physical network topology. In a particular implementation, the logical network agent 226 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols such as stateless transport tunneling (STT), Network Virtualization using Generic Routing Encapsulation (NVGRE), or Geneve, instead of, or in addition to, VXLAN.

The SDDC 200 also includes a virtualization manager 230 that communicates with the hosts 210 via a management network 232. In an embodiment, the virtualization manager 230 is a computer program that resides and executes in a computer system, such as one of the hosts, or in a virtual computing instance, such as one of the virtual machines 208 running on the hosts. One example of the virtualization manager 230 is the VMware vCenter Server® product made available from VMware, Inc. In an embodiment, the virtualization manager is configured to carry out administrative tasks for a cluster of hosts that forms an SDDC, including managing the hosts in the cluster, managing the virtual machines running within each host in the cluster, provisioning virtual machines, migrating virtual machines from one host to another host, and load balancing between the hosts in the cluster.

As noted above, the SDDC 200 also includes the logical network manager 228 (which may include a control plane cluster), which operates with the logical network agents 226 in the hosts 210 to manage and control logical overlay networks in the SDDC 200. Logical overlay networks comprise logical network devices and connections that are mapped to physical networking resources, e.g., switches and routers, in a manner analogous to the manner in which other physical resources as compute and storage are virtualized. In an embodiment, the logical network manager 228 has access to information regarding physical components and logical overlay network components in the SDDC. With the physical and logical overlay network information, the logical network manager 228 is able to map logical network configurations to the physical network components that convey, route, and filter physical traffic in the SDDC 200. In one particular implementation, the logical network manager 228 is a VMware NSX® product running on any computer, such as one of the hosts or a virtual machine in the SDDC 200.

The SDDC 200 also includes a gateway 234 to control network traffic into and out of the SDDC 200. In an embodiment, the gateway 234 may be implemented in one of the virtual machines 208 running in the SDDC 200. In a particular implementation, the gateway 234 may be an edge services gateway. One example of the edge services gateway 234 is VMware NSX® Edge™ product made available from VMware, Inc.

In the illustrated embodiment, the SDDC 200 includes a point-of-presence (POP) device 236 that is acting as a bastion host to validate connections to various components in the SDDC 200, such as the hypervisors 224, the logical network manager 228, the virtualization manager 230 and the edge services gateway 234. Thus, the POP device 236 ensures only trusted connections are made to the various components in the SDDC 200.

The SDDC 200 further includes an remediating and troubleshooting service (RTS) agent 238, which communicates with the RTS 102, to support the RTS to execute vulnerability scans and patching operations on the SDDC 200. In some embodiments, the RTS agent 238 may be integrated or embedded into any component in the SDDC 200, such as the POP device 236, the virtualization manager 230, the logical network manager 228 or any of the hypervisors 224. In a particular embodiment, the RTS agent 238 is installed within the POP device 236. The operations executed by the RTS agent 238 are described below.

As noted above, the RTS 102 uses vulnerability scan definitions and patch definitions to efficiently execute vulnerability scans and patching operations throughout a fleet of SDDCs for entities, such as all the SDDCs 104 illustrated in FIG. 1. The vulnerability scan definitions allow the RTS 102 to detect vulnerabilities in the SDDCs 104 using one or more vulnerability detectors, which are specified in the vulnerability scan definitions. A vulnerability is detected when one or more vulnerability detectors, which are specified in a vulnerability scan definition, scan one or more components in a target SDDC and one or more trigger conditions are satisfied. That is, depending on a scan definition for a vulnerability, the vulnerability may be detected when a single vulnerability detector, which is specified in the vulnerability scan definition, scans one or more components in a target SDDC and a single trigger condition is satisfied. For another scan definition for another vulnerability, this vulnerability may be detected when multiple vulnerability detectors, which are specified in the vulnerability scan definition, scan one or more components in a target SDDC and multiple trigger conditions are satisfied. When a vulnerability is detected, a patching operation may be executed to remediate the vulnerability. The patching operation that is needed for the detected vulnerability is specified in the patch definition, which corresponds to the vulnerability scan definition for the detected vulnerability.

These scan and patch definitions enable the RTS 102 to handle new vulnerabilities with respect to vulnerability scans and patching. For each new vulnerability, a new scan and/or patch definitions can be authored so that the RTS 102 can handle the new vulnerability. Thus, the RTS 102 can evolve to handle any vulnerability that can be found in the SDDCs 104 by detecting these vulnerabilities and then optionally applying patches to resolve the vulnerabilities.

In an embodiment, a vulnerability scan definition is a configuration document, e.g., a YAML (YAML Ain’t Markup Language) configuration document, that serves as a vulnerability signature. This signature contains vulnerability detectors and other related metadata to be interpreted by the RTS 102 to scan a single SDDC for a vulnerability, which may be any issue that may negatively affect the SDDC, such as a security vulnerability or a performance vulnerability.

Every vulnerability scan definition is structured to focus and answer two important questions about a vulnerability: (1) what is scanned? and (2) when should the scan run? Thus, the vulnerability scan definition includes a globally unique identifier with a description signature that makes identification and correlation easier. These fields may contain a common vulnerabilities and exposures (CVE ) or proprietary security advisory and description, if available. In addition, the vulnerability scan definition includes a when condition that allows scoping down the applicability of a vulnerability to properties of an SDDC. This when condition can be used to do version checking.

The vulnerability scan definition also specifies one or more vulnerability detectors to run as part of the scan, and one or more decision making expressions. Any decision making expression that evaluates to true will signify that the vulnerability detector (in effect the scanner) found something (i.e., a vulnerability) that may need remediation.

A vulnerability detector is a sub-configuration in a vulnerability scan definition that defines how a vulnerability should be detected. In an embodiment, the vulnerability detector has a predefined parameter schema. The vulnerability detector may run on an RTS agent or a target SDDC component, pulling data from the SDDC being scanned. Decision making for a vulnerability detector is performed through configuration set forth in the vulnerability detector. In an embodiment, the vulnerability detectors are extensible. As an example, the vulnerability detectors may probe an Hypertext Transfer Protocol (HTTP) endpoint, look for a pattern in log files, check for a specific response to a command or port, check for a specific setting or value in a configuration file, and/or check for a specific version of a file via install information or checksum on a present file.

In an embodiment, a vulnerability scan definition maps one-to-one for each discovered vulnerability. However, the vulnerability scan definition may contain more than one way of detecting the vulnerability through the concept of vulnerability detectors. A vulnerability scan definition can be restricted to run for specific versions. As an example, the following statement can be used in a vulnerability scan definition to restrict the scanner to all SDDCs lower than version 1.17:

when: <% version($.sddc.version) < version(‘1.17’) %>

As another example, the following statement can be used in a vulnerability scan definition to restrict the scanner to all SDDCs higher than version 1.15 and lower than version 1.17 (effectively 1.16):

# Multiple conditions can be combined together with and & or logical operators
when: <% version($.sddc.version) > version(‘1.15’) and version($.sddc.version)<
version(‘1.17’) %sdfs

The following tables are examples of possible supported version comparison operators.

| | | | |
|---|---|---|---|
| Type | Description | Expression | Behavioral Example |
| = | Equals To | <% version($.sddc. version) = version (‘1.17’) %> | version(‘1.17.2’) = version(‘1.17’) will be evaluated as True because the user is defining the major version. Similarly, version(‘1.17.2’) = version(‘1.17.3’) will be evaluated as False because the user has now defined the minor version also. |
| != | Not Equals To | <% version($.sddc. version) != version (‘1.17’) %> | version(‘1.17.2’) != version(‘1.17’) will be evaluated as False because the condition is false for the major version. Similarly, version(‘1.17.2’) !=version(‘1.17.3’) will be evaluated as True. |
| > | Greater Than | <% version($.sddc. version) > version (‘1.17’) %> | version(‘1.18.2’) > version(‘1.17’) will be evaluated as True and version(‘1.17.2’) > version(‘1.17’) will be evaluated as False because when comparing 17 with 17 it is equal not greater. |
| >= | Greater Than or Equal To | <% version($.sddc. version) <= version (‘1.17’) %> | version(‘1.17.2’) >= version(‘1.17’) will be evaluated as True as 17 = 17 and version(‘1.17.2’) > version(‘1.17.3’) will be evaluated as False. |
| < | Less Than | <% version($.sddc. version) < version (‘1.17’) %> | version(‘1.17.2’) < version(‘1.17’) will be evaluated as False as 17 is equal to 17 not greater and version(‘1.16.2’) < version(‘1.17’) will be evaluated as True |
| <= | Less Than or Equal To | <% version($.sddc. version) <= version (‘1.17’) %> | version(‘1.17.2’) <= version(‘1.17’) will be evaluated as True as 17 = 17 and version(‘1.17.2’) <= version(‘1.17.1’) will be evaluated as False. |

Note: Major or minor versions of the SDDC can be mentioned. As an example, for SDDC version 1.16.3.4, the major version may be 1.16 and the minor version may be 3.4.

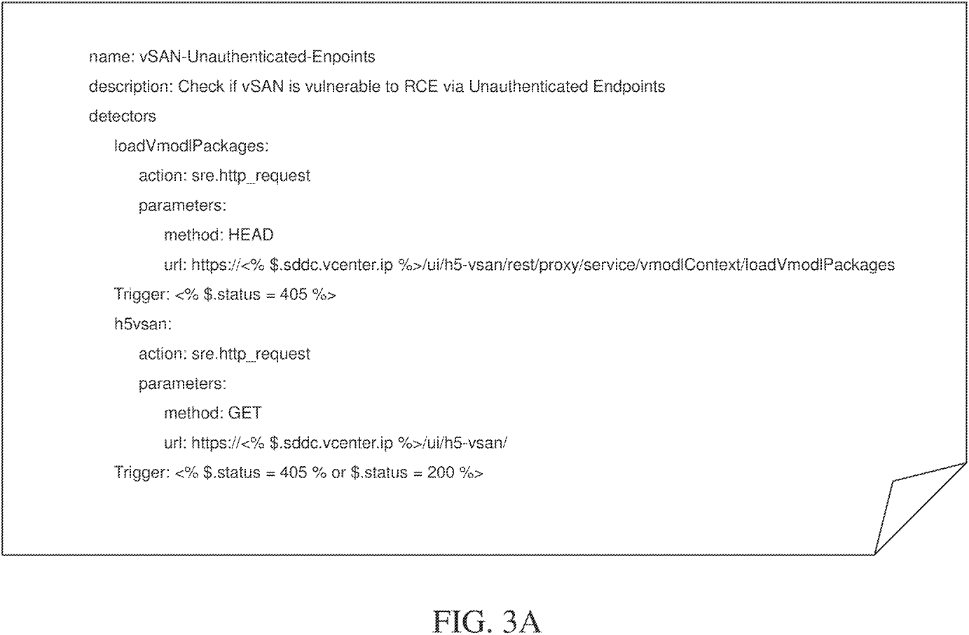

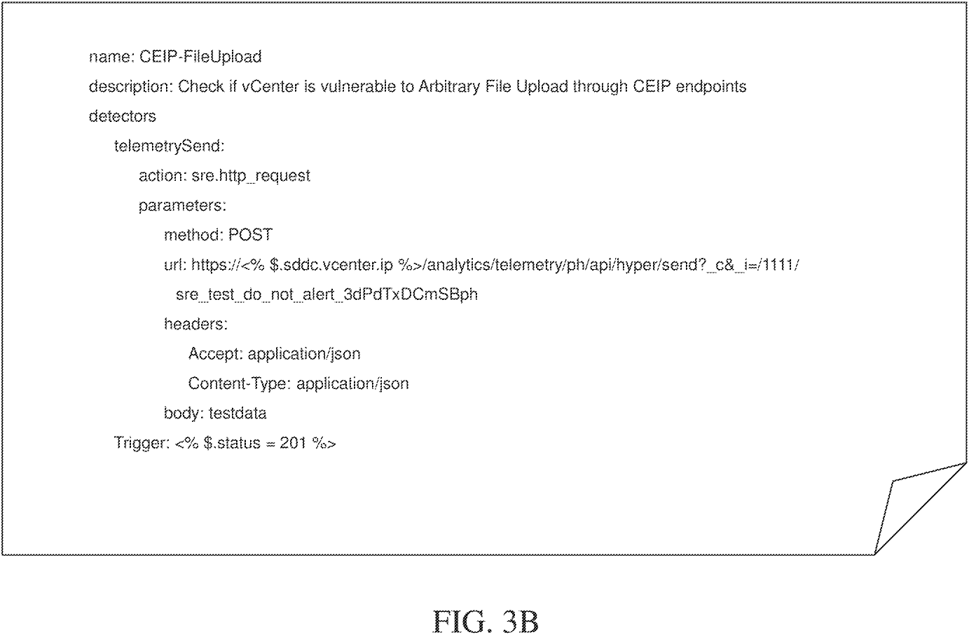

A sample vulnerability scan definition using Hypertext Transfer Protocol (HTTP) GET in accordance with an embodiment is shown in FIG. 3A. As illustrated, the vulnerability scan definition includes name and description to identify this vulnerability scan definition. In this example, the name of the vulnerability scan definition is “vSAN-Unauthenticated-Endpoints,” and the description is “Check if vSAN is vulnerable to RCE via Unauthenticated Endpoints.” The vulnerability scan definition includes two vulnerability detectors, “LoadVmodlPackages” and “h5vsan.” Thus, multiple vulnerability detectors can be used for a single signature. However, a vulnerability scan definition may include any number of vulnerability detectors, including only one vulnerability detector. The vulnerability detectors can be chosen from a library of standard vulnerability detectors. For each vulnerability detector specified in the vulnerability scan definition, there are action, parameters and trigger. The action of both vulnerability detectors in the vulnerability scan definition is “sre.http.request.” The trigger for the LoadVmodlPackages detector is <% $.status = 405%>. The trigger for the h5vsan detector is <% $.status = 405 or % $.status = 200%>. Each of these triggers specifies a triggering condition that qualifies as a vulnerable SDDC. The parameters of the two vulnerability detectors include method and URL, which are templatized parameter values using SDDC information. The methods of the LoadVmodlPackages detector and the h5vsan detector are HEAD and GET, respectively. The URLs and the two vulnerability detectors specify the locations for the vulnerability detectors to retrieve the needed information. This vulnerability scan definition may specify that a vulnerability is found when either one of the two vulnerability detectors detects the vulnerability (i.e., a triggering condition is satisfied) or when both vulnerability detectors detect the vulnerability.

A sample vulnerability scan definition using HTTP POST in accordance with an embodiment is shown in FIG. 3B. As illustrated, the vulnerability scan definition also includes name and description to identify the vulnerability scan definition. In this example, the name of the vulnerability scan definition is “CEIP-FileUpload,” and the description is “Check if vCenter is vulnerable to Arbitrary File Upload through CEIP endpoints.” The vulnerability scan definition includes a single vulnerability detector, “telemetrySend,” which includes action, parameters and trigger. The action of the vulnerability detector is “sre.http.request.” The trigger for the vulnerability detector is <% $.status = 201%>. The parameters include method, URL, headers and body. The headers include accept and content-type fields.

In an embodiment, similar to a vulnerability scan definition, a patch definition is a configuration document, e.g., a YAML configuration document, that serves as patch metadata. This signature contains the action name and its parameters to be interpreted by the RTS 102 to patch a single SDDC.

Every patch definition is structured to focus and answer two important questions about a vulnerability: (1) what is patched? and (2) how it is patched? Thus, similar to a vulnerability scan definition, the patch definition includes a globally unique identifier with a description signature that makes identification and correlation easier. These fields may contain a common vulnerabilities and exposures (CVE ) or proprietary security advisory and description, if available. In addition, the patch definition includes a list of parameters and parameter interpolation. The parameters contain the action (and its parameters) to be executed in order to patch any SDDC. The parameters for the action are interpolated using an expression, e.g., a YAQL (Yet Another Query Language) expression.

A parameter is a subconfiguration in a patch definition that defines which RTS script is to be executed in order to patch the identified vulnerability. In an embodiment, the parameters have a predefined parameter schema. The action specified in the parameters can be any type of script.

In an embodiment, a patch definition maps one-to-one for each discovered vulnerability. The name field in a patch definition should match the name field of the corresponding vulnerability scan definition.

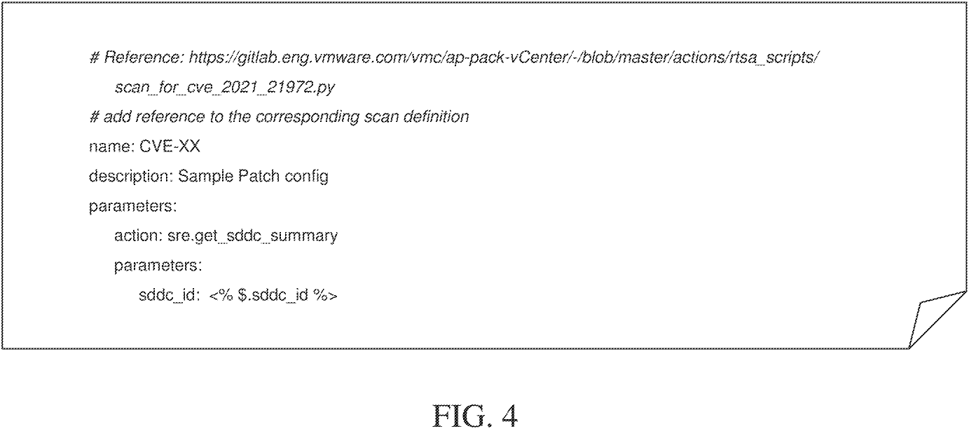

A sample patch definition in accordance with an embodiment is shown in FIG. 4. As illustrated, the patch definition includes name and description to identify this patch definition. In this example, the name of the patch definition is “CVE-XX,” and the description is “Sample Patch config.” The patch definition further includes a list of parameters, which contain action and parameters. The action can be any RTS action. In this sample patch definition, only one parameter, sddc_id, is listed. The sddc_id parameter is <% $.sddc.id %>. In an embodiment, the patch definition might define additional pre-requisite conditions for applying the patch, such as, patch X must also be applied before patch Y.

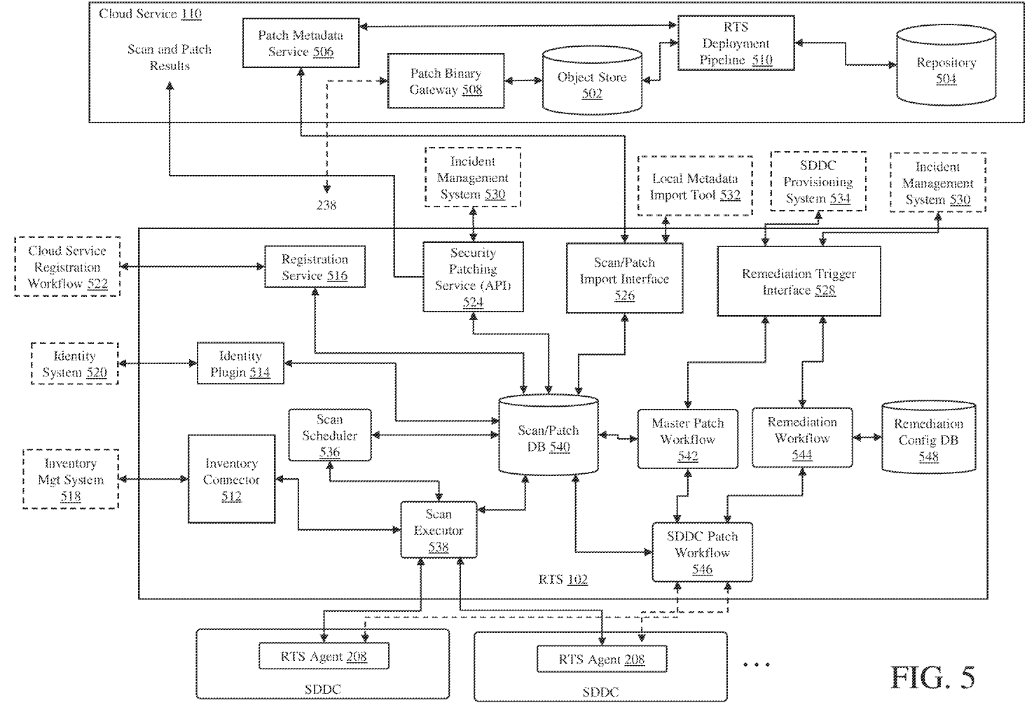

Turning now to FIG. 5, components of the RTS 102 and components of the cloud service 110 in accordance with an embodiment of the invention are illustrated. As shown in FIG. 5, the cloud service 110 includes an object store 502 and a repository 504. The object store 502 is used to store binaries before delivery. The stored binaries include different patch binaries, which may be needed to patch one or more SDDC components. In an embodiment, these binaries are approved binaries to ensure chain-of-control of all security patches. The repository 504 includes build and release data, which is needed to build patch binaries via an RTS deployment pipeline 510, which may be a continuous integration/continuous delivery (CI/CD) pipeline.

The cloud service 110 further includes a patch metadata service 506 and a patch binary gateway 508. The patch metadata service 506 provides metadata related to patches that are needed by the RTS 102. Metadata provided by the patch metadata service 506 includes, but not limited to, vulnerability descriptions, vulnerability signatures (i.e., vulnerability scan definitions), scanning schedule and patch metadata (i.e., patch definitions). The patch binary gateway 508 operates to deliver patch binaries, which are stored in the object store 502, to the RTS agents 238 of the SDDCs 104, if required.

The RTS 102 includes a number of connectors to communicate with various systems and the cloud service 110. In some embodiment, the various systems may be part of the cloud service 110 or part of an on-premises operational environment. The connectors of the RTS include an inventory connector 512, an identity plugin 514 and a registration service 516. The inventory connector 512 is connected to an inventory management system 518 to receive information regarding the various SDDCs 104 and their components, which can be used to perform scans and patching operations. The identity plugin 514 is connected to an identity system 520 to receive usernames and passwords of administrator to access the RTS 102. The registration service 516 is connected to a cloud service registration workflow 522 to register with the cloud service 110 to access the cloud scan and patch information, which requires input from an administrator.

The RTS 102 further includes a security patching service 524, a scan/patch import interface 526 and a remediation trigger interface 528. The security patching service 524 is used to push scan and patch results from the RTS 102 to the cloud service 110. The security patching service 524 is also used to connect with an incident management system 530, which may be a typical ticketing system that raises a ticket when a vulnerability is detected. This service allows detections and patch information to be queried in response to raised tickets, such as what scans have been run, and what patches have been applied. The scan/patch import interface 526 is used to connect to the patch metadata service 506 in the cloud service 110 to pull in scan and patch definitions. In addition, the scan/patch import interface 526 is used to connect to a local metadata import tool 532 to pull in local scan and/or patch definitions as an alternative. The remediation trigger interface 528 is used to connect with an SDDC provisioning system 534 to receive a remediation trigger signal or command so that the RTS 102 can remediate any issues with patches for an SDDC being deployed prior to delivery. The remediation trigger interface 528 is also used to connect with the incident management system 530 to receive a remediation trigger signal or command in response to a ticket for an incident (i.e., a detected vulnerability) so that the RTS 102 can auto-remediate the incident using a patch definition. In an embodiment, the inventory management system 518 and the incident management system 530 may be combined into a single system.

The RTS 102 also includes a scan scheduler 536 and a scan executor 538, which operate to facilitate vulnerability scans in select SDDC(s) 104. The scan scheduler 536 checks for scheduled scans within a scan/patch database 540, which is a persistent store. The scan scheduler 536 is configured to execute all pending scans. The scan scheduler 536 may use scan configuration from the scan/patch database 540. The scan configuration contains the vulnerability detector definition(s), the frequency that each vulnerability detector needs to be executed, the condition parameter that is needed to configure each vulnerability detector, and the trigger condition that determines if each vulnerability detector should signal a vulnerability, which requires remediation. In an embodiment, the scan scheduler 536 may limit the possible active number of scans based on configuration to limit resource utilization. When scans need to be executed, the scan executor 538 is directed by the scan scheduler 536 to execute the scans. The scan executor 538 operates to execute scans using the vulnerability detectors specified in the vulnerability scan definitions, and update the scan/patch database 540 with results of the scans. The scans are performed by the RTS agents 238 running in the SDDCs 104 where the scans are needed. In addition, if patching is required for a specific incident, this is alerted to the cloud service via the security patching service so that it can be remediated by the incident management system 530 using the remediation trigger interface 528.

The RTS 102 further includes a master patch workflow 542, a remediation workflow 544 and an SDDC patch workflow 546, which operate to facilitate patching operations on one or more SDDC components. The master patch workflow 542 operates to remediate all vulnerabilities that are required post-deployment when instructed via the remediation trigger interface 528 using available patches stored in the scan/patch database 540. The remediation workflow 544 operates to patch a specific vulnerability when instructed via the remediation trigger interface 528 using a remediation configuration stored in a remediation configuration database 548 or loaded from a disk. A remediation configuration is a map between the vulnerability and the patch information that needs to be executed to remediate the vulnerability. The patch information may include all parameterized information that is needed to execute, which can be templatized since some of the data will be passed as part of the remediation alert/event. An example of this data is the SDDC identification (ID). In an embodiment, the remediation workflow 544 may also use patches stored in the scan/patch database 540. The SDDC patch workflow 546 operates to remediate a specific SDDC component or a number of SDDC components when required by either the master patch workflow 542 or the remediation workflow 544 using patch details from the scan/patch database 540. The patch details may include the script or scripts that need to be executed, and references to any binaries required, which would be downloaded from the cloud service 110 and validated to ensure that the binaries are approved binaries only. In addition, the patch details may include templatized parameters that leverage data that has been provided by the scanning tool to pass as parameters to the patch, such as specific SDDC ID, or specific appliance/instance that needs to be patched. The patching operations are executed by the RTS agents 238 running in the SDDCs 104 where the patching operations are needed.

In an embodiment, when a vulnerability is detected, a vulnerability scan definition may be created to understand the exposure of the fleet of SDDCs. Until a patch is created for the detected vulnerability, mitigation remediation may be leveraged, i.e., a patch is not applied, but exposure is limited. When a patch is created, scanning is continued to detect the vulnerability, and patch is applied as necessary, until the vulnerability is no longer applicable. This mitigates the potential for issues related to regressions.

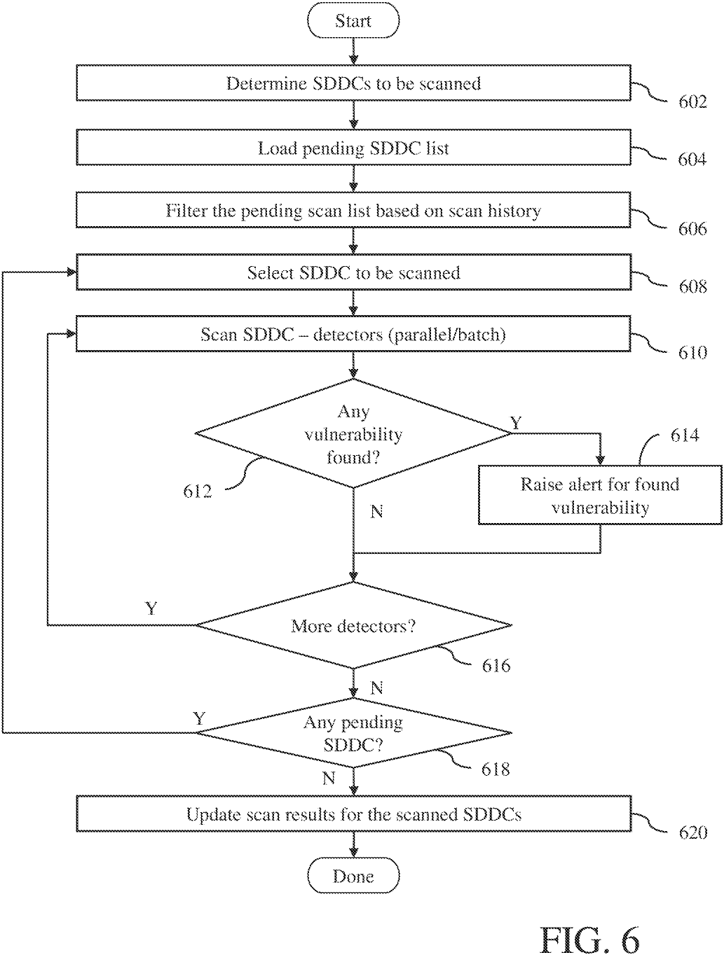

Turning now to FIG. 6, a flow diagram of a process of scanning the SDDCs 104 in the computing system 100 for vulnerabilities in accordance with an embodiment of the invention is shown. The process begins at step 602, where the SDDCs to be scanned are determined by the scan executor 538 based on information from the inventory management system 518. As a result of this determination, a pending SDDC list, i.e., a list of SDDCs to be scanned, is produced.

Next, at step 604, the pending SDDC list is loaded for processing by the scan executor 538. Next, at step 606, the pending SDDC list is filtered based on scan history by the scan executor 538. Thus, SDDCs that were recently scanned and patched may be removed from the pending SDDC list. Next, at step 608, an SDDC in the pending SDDC list is selected to be processed by the scan executor 538.

Next, at step 610, the selected SDDC is scanned by a RTS agent 238 in the selected SDDC, as directed by the scan executor 538, using a vulnerability detector specified in a vulnerability scan definition for the selected SDDC. In an embodiment, the vulnerability scan definitions for all the scans that need to be scheduled for vulnerability scans are sent to the appropriate RTS agents 238 in the different SDDCs 104. In addition, any executable components that are needed to execute the scans are provided to the RTS agents via the artifact repository (i.e., the patch binary gateway 508) from the cloud service 110. If more than one vulnerability detector is specified in the vulnerability scan definition, the SDDC is scanned using the first vulnerability detector specified in the vulnerability scan definition. In an embodiment, the first vulnerability detector may be the topmost detector listed in the vulnerability scan definition. The RTS agent 238 is configured to notify the scan executor 538 when a vulnerability is found by a vulnerability detector, i.e., a vulnerability condition is determined to be satisfied by the vulnerability detector. In an embodiment, the vulnerability detectors configured with the vulnerability scan definition may be executed in parallel on the selected SDDC. So, the manifest of the vulnerability detectors and configuration is sent and run without round trips with the cloud infrastructure. Therefore, they are sent in a batch (i.e., one or more vulnerability detector configurations) and executed in parallel based on available resources in the RTS agent 238. This allows for efficient execution of the vulnerability scans across disparate on-prem and cloud environments.

Next, at step 612, a determination is made by the scan executor 538 whether any vulnerability has been found using the current vulnerability detector. If a vulnerability has been found, an alert is raised for the found vulnerability by the scan executor 538, at step 614. The process then proceeds to step 616. However, if a vulnerability has not been found, the process proceeds directly to step 616.

At step 616, a determination is made by the scan executor 538 whether there is another vulnerability detector listed in the vulnerability scan definition. If there is another vulnerability detector in the vulnerability scan definition, the process proceeds back to step 610 to execute another scan on the SDDC using this vulnerability detector. However, if there are no more vulnerability detectors in the vulnerability scan definition, the process proceeds to step 618.

At step 618, a determination is made by the scan executor 538 whether there is another pending SDDC to be scanned in the pending SDDC list. If there is another pending SDDC, the process proceeds back to step 608 to select another pending SDDC to be processed. However, if there are no more pending SDDCs, then the scan results are updated for the scanned SDDCs in the scan/patch database 540 by the scan executor 538, at step 620. The process then comes to an end.

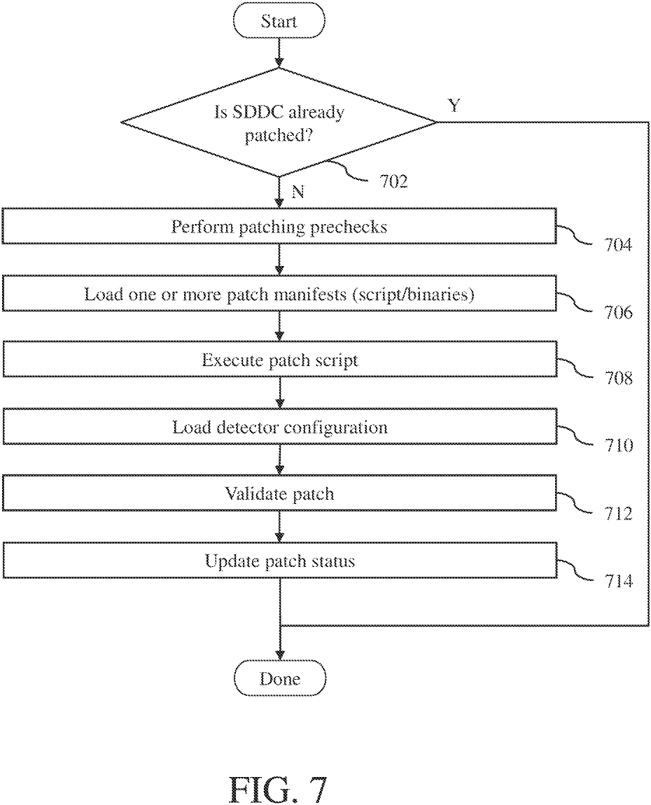

Turning now to FIG. 7, a flow diagram of a process of patching an SDDC in the computing system 100 in accordance with an embodiment of the invention is shown. This patching process is performed by the SDDC patch workflow 546 of the RTS 102. The SDDC being processed is an SDDC that has been determined to need or potentially need patching by the master patch workflow 542 or the remediation workflow 544. Thus, the entry point of this process can either be the master patch workflow 542 or the remediation workflow 544. This depends on how this process is invoked. If the master patch workflow 542 is involved, this process ensures that all patches are installed, which may be performed post-provisioning, as an example. If the remediation workflow 544 is involved, this process is performed as a specific response to an alert that a particular SDDC has a particular vulnerability.

The patching process begins at step 702, where a determination is made by the SDDC patch workflow 546 whether the SDDC being processed has already been patched. If the SDDC has already been patched, then the process comes to an end. However, if the SDDC has not been already patched, then the process proceeds to step 704, where one or more patching prechecks are performed by the SDDC patch workflow 546. In an embodiment, the patching prechecks may include (1) a determination of whether a patch is applicable to this SDDC version or function and (2) whether the SDDC is in a state that it can be patched, e.g., not currently in upgrade or component is not available.

Next, at step 706, one or more patch manifests are loaded by the SDDC patch workflow 546. These would include the patch script that needs to be executed to patch and references to binaries or configuration data to execute that patch. A patch manifest is a meta-definition of the files that should be used by the patch script to apply the patch. A patch script is an action specified in a patch definition that may be used to apply the patch on a specified SDDC component or instance.

Next, at step 708, a patch script is executed by the SDDC patch workflow 546. During this step, the patch manifest is executed by an RTS agent 238 in the SDDC being processed to perform the patching operation on the SDDC or an SDDC component.

Next, at step 710, detector configuration is loaded by the SDDC patch workflow 546 to re-execute the specific scan for the vulnerability that has just been patched. The detector configuration, which may be similar to a vulnerability scan definition, includes all the information regarding the specific scan.

Next, at step 712, the patch is validated by the SDDC patch workflow 546. In an embodiment, one or more of the vulnerability detectors specified in the detector configuration are re-executed to ensure that the patch has been applied correctly and the vulnerability has been successfully remediated (i.e., the trigger rule(s) is/are not executed). Thus, the patch is validated when the re-execution of the vulnerability detector(s) does not detect the vulnerability in the SDDC.

Next, at step 714, the patch status of the SDDC is updated in the scan/patch database 540 by the SDDC patch workflow 546. The process then comes to an end.

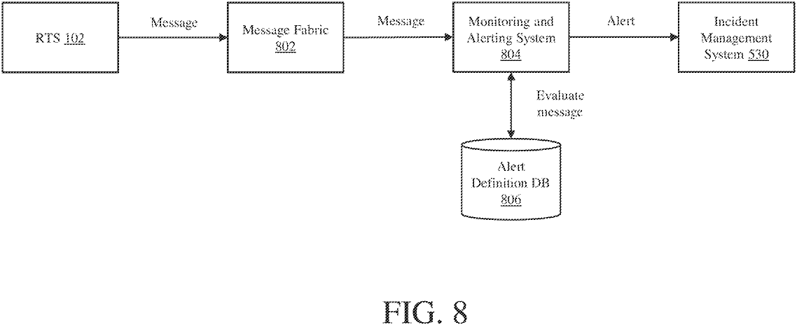

In an embodiment, the RTS 102 may use other components to alert to the incident management system 530. These other components may be components in the cloud service 110 or the on-premises operational environment in accordance with embodiments of the invention. As shown in FIG. 8, these other components include a message fabric 802, a monitoring and alerting system 804, and an alert definition database 806. The message fabric 802 is an asynchronous messaging bus to transmit a payload from the RTS 102 as a message. The monitoring and alerting system 804 operates to manage the vulnerability ticket until resolution. In particular, the monitoring and alerting system 804 evaluates whether the payload in the message from the RTS 102 matches one of the alert definitions, which are in the alert definition database 806. In an embodiment, if the payload does not match any of the alert definitions, the vulnerability ticket may be dropped. However, if the payload does match one of the alert definitions, an alert is generated and transmitted from the monitoring and alerting system 804 to the incident management system 530 to handle or resolve the incident.

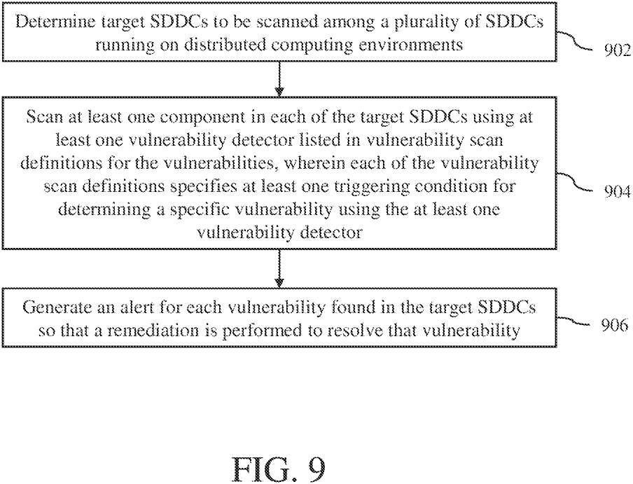

A computer-implemented method for scanning software-defined data centers (SDDCs) for vulnerabilities in accordance with an embodiment of the invention is described with reference to a process flow diagram of FIG. 9. At block 902, target SDDCs to be scanned among a plurality of SDDCs running on distributed computing environments are determined. At block 904, at least one component in each of the target SDDCs is scanned using at least one vulnerability detector listed on vulnerability scan definitions for the vulnerabilities. Each of the vulnerability scan definitions specifies at least one triggering condition for determining a specific vulnerability using the at least one vulnerability detector. At block 906, an alert is generated for each vulnerability found in the target SDDCs so that a remediation is performed to resolve that vulnerability.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for scanning software-defined data centers (SDDCs) for vulnerabilities, the method comprising:
determining target SDDCs to be scanned among a plurality of SDDCs running on distributed computing environments;
scanning at least one component in each of the target SDDCs using at least one vulnerability detector listed on vulnerability scan definitions for the vulnerabilities, wherein each of the vulnerability scan definitions specifies at least one triggering condition for determining a specific vulnerability using the at least one vulnerability detector; and
generating an alert for each vulnerability found in the target SDDCs so that a remediation is performed to resolve that vulnerability.

2. The computer-implemented method of claim 1, wherein at least one of the vulnerability scan definitions specifies multiple vulnerability detectors with multiple triggering conditions, and wherein generating the alert includes generating the alert when the multiple triggering conditions are satisfied.

3. The computer-implemented method of claim 1, wherein at least one of the vulnerability scan definitions specifies multiple vulnerability detectors with multiple triggering conditions, and wherein generating the alert includes generating the alert when one of the multiple triggering conditions is satisfied.

4. The computer-implemented method of claim 1, further comprising executing a patching operation using information in a patch definition on a particular target SDDC where a vulnerability was found, wherein the patch definition corresponds to a particular vulnerability scan definition used on the particular target SDDC for the vulnerability.

5. The computer-implemented method of claim 4, further comprising validating a patch used in the patching operation by re-executing the scanning of the particular target SDDC, wherein the patch is validated when the vulnerability is not found in the particular target SDDC.

6. The computer-implemented method of claim 1, wherein scanning at least one component in each of the target SDDCs includes executing a vulnerability scan on at least one component in each of the target SDDCs using agents in the target SDDCs, wherein a patching operation is also performed by one of the agents.

7. The computer-implemented method of claim 6, wherein at least one of the agents is integrated into a component of one of the target SDDCs.

8. The computer-implemented method of claim 1, wherein at least one of the target SDDCs is running on an on-premises computing environment and at least one of the target SDDCs is running on a public cloud computing environment.

9. A non-transitory computer-readable storage medium containing program instructions for scanning software-defined data centers (SDDCs) for vulnerabilities, wherein execution of the program instructions by one or more processors causes the one or more processors to perform steps comprising:
determining target SDDCs to be scanned among a plurality of SDDCs running on distributed computing environments;
scanning at least one component in each of the target SDDCs using at least one vulnerability detector listed on vulnerability scan definitions for the vulnerabilities, wherein each of the vulnerability scan definitions specifies at least one triggering condition for determining a specific vulnerability using the at least one vulnerability detector; and
generating an alert for each vulnerability found in the target SDDCs so that a remediation is performed to resolve that vulnerability.

10. The non-transitory computer-readable storage medium of claim 9, wherein at least one of the vulnerability scan definitions specifies multiple vulnerability detectors with multiple triggering conditions, and wherein generating the alert includes generating the alert when the multiple triggering conditions are satisfied.

11. The non-transitory computer-readable storage medium of claim 9, wherein at least one of the vulnerability scan definitions specifies multiple vulnerability detectors with multiple triggering conditions, and wherein generating the alert includes generating the alert when one of the multiple triggering conditions is satisfied.

12. The non-transitory computer-readable storage medium of claim 9, wherein the steps further comprise executing a patching operation using information in a patch definition on a particular target SDDC where a vulnerability was found, wherein the patch definition corresponds to a particular vulnerability scan definition used on the particular target SDDC for the vulnerability.

13. The non-transitory computer-readable storage medium of claim 12, wherein the steps further comprise validating a patch used in the patching operation by re-executing the scanning of the particular target SDDC, wherein the patch is validated when the vulnerability is not found in the particular target SDDC.

14. The non-transitory computer-readable storage medium of claim 9, wherein scanning at least one component in each of the target SDDCs includes executing a vulnerability scan on at least one component in each of the target SDDCs using agents in the target SDDCs, wherein a patching operation is also performed by one of the agents.

15. The non-transitory computer-readable storage medium of claim 14, wherein at least one of the agents is integrated into a component of one of the target SDDCs.

16. The non-transitory computer-readable storage medium of claim 9, wherein at least one of the target SDDCs is running on an on-premises computing environment and at least one of the target SDDCs is running on a public cloud computing environment.

17. A system comprising:
memory; and
at least one processor configured to:
determine target SDDCs to be scanned among a plurality of SDDCs running on distributed computing environments;
scan at least one component in each of the target SDDCs using at least one vulnerability detector listed on vulnerability scan definitions for the vulnerabilities, wherein each of the vulnerability scan definitions specifies at least one triggering condition for determining a specific vulnerability using the at least one vulnerability detector; and
generate an alert for each vulnerability found in the target SDDCs so that a remediation is performed to resolve that vulnerability.

18. The system of claim 17, wherein at least one of the vulnerability scan definitions specifies multiple vulnerability detectors with multiple triggering conditions, and wherein generating the alert includes generating the alert when one of the multiple triggering conditions is satisfied or when the multiple triggering conditions are satisfied.

19. The system of claim 17, wherein the at least one processor configured to execute a patching operation using information in a patch definition on a particular target SDDC where a vulnerability was found, wherein the patch definition corresponds to a particular vulnerability scan definition used on the particular target SDDC for the vulnerability.

20. The system of claim 19, wherein the at least one processor configured to validate a patch used in the patching operation by re-executing a scan of the particular target SDDC, wherein the patch is validated when the vulnerability is not found in the particular target SDDC.
